(19) United States
(12) Patent Application Publication
(10) Pub. No.: US 2011/0215986 A1
(43) Pub. Date: Sep. 8, 2011

(54) Antenna Assembly

(75) Inventor: Martyn Tongue, Leicestershire (GB)

(73) Assignee: Sarantel Limited

(21) Appl. No.: 12/887,220

(22) Filed: Sep. 21, 2010

Related U.S. Application Data
(60) Provisional application No. 61/310,483, filed on Mar. 4, 2010.

(51) Int. Cl. H01Q 1/50; H01Q 1/36; H01P 11/00

(52) U.S. Cl. 343/895; 343/906; 29/600

(57) ABSTRACT

An antenna assembly includes a combination of a dielectrically loaded antenna unit for operation at a frequency in excess of 200 MHz and a connector secured to the antenna unit, wherein the antenna unit has a side surface and end surfaces and has a solid insulative dielectric core and an antenna element structure having a plurality of conductive antenna elements arranged on or adjacent the outer surface of the core, and wherein the connector includes an inner connection member that is coupled to at least one of the antenna elements and that projects from a central portion of one of the end surfaces of the antenna unit, and a hollow outer connection member that encircles the inner connection member and has an unattached annular edge and an attached annular edge, the attached annular edge being bonded to the one end surface of the antenna unit.

### CROSS-REFERENCE TO RELATED APPLICATION

The present application claims the benefit of the filing date of U.S. Provisional Patent Application No. 61/310,483 filed on Mar. 4, 2010, currently pending, the entire disclosure of which is hereby incorporated herein by reference.

### BACKGROUND OF THE INVENTION

This invention relates to an antenna assembly comprising the combination of a dielectrically loaded antenna unit and a connector secured to the antenna unit. The invention is primarily applicable to the assembly of a dielectrically-loaded helical antenna unit for operation at a frequency in excess of 200 MHz and a coaxial connector.

It is known to dielectrically load helical antennas for operation at UHF frequencies. Typically, such an antenna includes a cylindrical ceramic core having a relative dielectric constant of at least 5, the outer surface of the core bearing an antenna element structure in the form of helical conductive tracks. In the case of a so-called “backfire” antenna, an axial feeder is housed in a bore extending through the core between proximal and distal transverse outer surface portions of the core, conductors of the feeder being coupled to the helical tracks via conductive surface connection elements on a distal transverse surface portion of the core. Such antennas are generally described in published British Patent Applications Nos. GB2292638, GB2309592, GB2399948, GB2441566, GB2445478, International Application No. WO2006/136809 and U.S. Published Application No. 2008/0174512.

British Patent Application No. GB2444388 discloses a so-called “end-fire” antenna.

These published documents generally describe antennas having one, two, three or four pairs of helical antenna elements or groups of helical antenna elements. WO2006/136809, GB2441566, GB2445478 and US2008-0174512A1 each generally describe an antenna with an impedance matching network including a printed circuit laminate board secured to the distal outer surface portion of the core, the network forming part of the coupling between the feeder and the helical elements. The above published applications, in their entirety, are incorporated herein by reference.

GB2444388 and corresponding U.S. patent application Ser. No. 11/998,471 disclose the combination of an end-fire antenna and a printed circuit laminate board extending longitudinally, i.e. parallel to a central axis of the antenna, circuitry on the laminate board being connected directly to the helical antenna elements on a proximal outer surface portion of the core. In an alternative variant, the antenna is mounted directly on the face of a printed circuit laminate board.

In situations in which the antenna is to be detachable from the circuitry equipment on which it is mounted, a coaxial connector may be provided on an axial printed circuit board or on an extension of a coaxial feed structure passing through the antenna core.

### SUMMARY OF THE INVENTION

According to a first aspect of this invention, there is provided an antenna assembly comprising the combination of a dielectrically loaded antenna unit for operation at a frequency in excess of 200 MHz and a connector secured to the antenna unit, wherein the antenna unit has a side surface and end surfaces and comprise a solid insulative dielectric core and an antenna element structure having a plurality of conductive antenna elements arranged on or adjacent the outer surface of the core, and wherein the connector comprises an inner connection member which is coupled to at least one of the antenna elements and which projects from a central portion of one of the end surfaces of the antenna unit, and a hollow outer connection member which encircles the inner connection member and has an unattached annular edge and an attached annular edge, the attached annular edge being bonded to the said one edge surface of the antenna unit. It is preferred that the outer connection member is a conductive sleeve having a generally circular attached edge and that the transverse end surface of the antenna unit to which the outer connection member is attached has a conductive outer layer. The attached edge of the sleeve may, therefore, be conductively bonded around its circumference directly to the conductive outer layer. In the preferred embodiment of the invention, the antenna unit and the connector have a common central axis and the inner connection member is a connector pin lying on the axis. In the case of a backfire helical antenna, having an axial feeder structure passing through the core, the inner connection member may form an extension of one of the conductors of the feeder structure, either as a pin soldered to the feeder structure conductor or as an integrally formed projecting section of a single-piece feed conductor passing through the length of the core.

Typically, the antenna unit core is cylindrical, and the antenna element structure comprises a plurality of conductive helical antenna elements on the cylindrical outer surface of the core and extending from the region of a feed connection on one transverse surface of the core in the direction of a an opposite transverse surface of the core. A proximal region of the core may be covered by a conductive layer to which the outer connection member of the connector is directly soldered. The outer connection member may comprise a generally cylindrical conductive shell with a circular attached edge soldered to the conductive coating along the whole length of the attached edge.

To protect the antenna assembly, a polymeric cover may be moulded over the combination of the antenna unit and the connector, the outer connection member having a non-circular outer profile to prevent rotation of the connector inside the moulded covering.

The preferred connector includes a solid insulative spacer inside the outer connection member and surrounding the inner connection member, the conductive outer shell of the connector having an inner shoulder to trap the spacer against the end surface of the antenna unit.

The preferred antenna unit is a helical antenna having a cylindrical core and one or more pairs of conductive helical elements on the outer cylindrical surface of the core, the helical elements being generally coextensive and having a common radius. The outer connection member is typically coupled to at least one of the helical elements.

According to another aspect of the invention, there is provided a method of making an antenna assembly as described above, the unit to which the connector is secured having a conductive coating, wherein the method comprises locating a solder ring and the attached annular connector edge on the said one end surface, the solder ring being in contact with the annular edge, and heating the antenna unit and the connector to cause the solder of the solder ring to flow between the conductive coating and the connector edge to form a solder bond between them.

Preferably, the dielectric spacer is placed around the inner connection member before the outer connection member is bonded to the antenna unit in order that it is trapped by the outer connection member. Alternatively, the dielectric spacer may be inserted in the outer connection member itself before the latter is located on the antenna unit.

It is preferred that the axial length of the outer connection member is no more than twice the average transverse extent of the attached edge of the outer connector member. In the preferred embodiment, the axial length is less than the average transverse extent of the attached edge. Where the outer connection member is cylindrical, the average transverse extent is the outer diameter of the attached edge.

The antenna assembly described herein provides a robust and compact module that can be readily attached to and detached from radio frequency receiver and/or transmitter equipment.

### BRIEF DESCRIPTION OF THE DRAWINGS

The invention will now be described by way of example with reference to the drawings in which:

FIG. 1 is an exploded perspective view of an antenna assembly in accordance with the invention, comprising an antenna unit and a connector;

FIG. 2 is an exploded view of the assembly, part-assembled and shown with an inner connector pin of the connector in place;

FIG. 3 is a perspective view of the assembly with the whole of the connector secured to the antenna unit; and

FIG. 4 is a perspective view from a proximal end of the assembly, the assembly being encapsulated in a plastics outer covering.

### DETAILED DESCRIPTION OF THE DRAWINGS

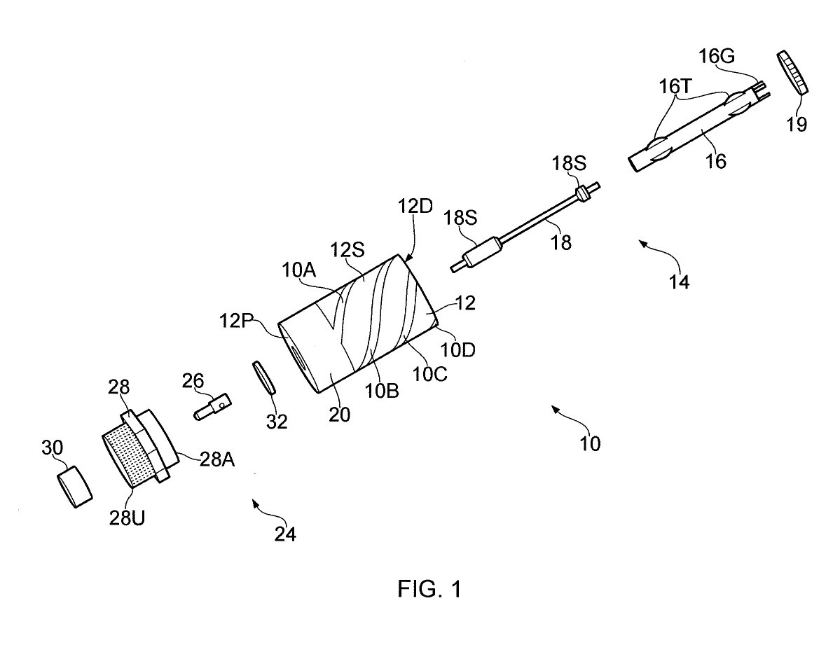

Referring to FIG. 1, an antenna assembly in accordance with the invention has a dielectrically-loaded antenna unit 10 for operation at a frequency in excess of 200 MHz. The antenna unit has a cylindrical electrically insulative core 12 of a solid material having a relative dielectric constant greater than 5, typically greater than 20, with a cylindrical side surface 12S and axially directed proximal and distal transverse surfaces 12P, 12D. On the cylindrical surface 12S of the core, there is a three-dimensional antenna element structure 10A-10D including at least one pair of elongate conductive antenna elements disposed on or adjacent the surface and each extending from the distal surface 12D of the core in the direction of the proximal surface. In this embodiment, the antenna unit is a quadrifilar helical antenna in which the antenna element structure comprises four elongate conductive helical elements 10A-10D plated on the cylindrical surface 12S. The antenna unit is intended for circularly polarised GPS signals at 1575 MHz.

The core 12 has an axial bore which receives an axial feed structure 14 comprising the combination of a coaxial transmission line section and a transversely extended matching section. The transmission line section, in this embodiment, is coaxial, having a tubular shield conductor 16 and an inner rod conductor 18 carrying spacers 18S to centralise the rod 18 within the tubular shield 16 with an air gap therebetween. The matching section takes the form of a laminate board 19 which, when the antenna unit is assembled, receives distal end lugs 16G of the shield conductor 16 and lies on the distal surface 12D of the core where conductors of the matching section on the laminate board 19 are soldered to conductors on the distal surface 12D, which conductors are connected to the helical elements 10A-10D.

The inner rod 18 of the transmission line section is dimensioned to have its distal end received in the laminate board 19 and its proximal end portion projecting proximally from the proximal surface 12P of the core 12.

The shield conductor 16 has radially projecting tangs 16T which centralise the transmission line section in the axial bore of the core 12.

To provide a balanced feed at the distal end of the antenna unit, the core 12 carries a conductive sleeve 20 to which the antenna elements 10A-10D are each connected, the conductive layer represented by the sleeve 20 extending over the proximal edge of the cylindrical side surface 12S of the core so as to be electrically continuous with a conductive covering layer on the proximal end transverse surface 12P of the core. When the antenna unit is assembled, the plated layer on the proximal surface 12P is connected to the proximal end of the shield conductor 16 of the transmission line section passing through the core where is emerges from the bore at its proximal end. The sleeve forms a quarter-wave balun.

The antenna unit 10 is described in more detail in WO2006/136809 and corresponding U.S. patent application Ser. No. 11/472,586, the entire disclosure of which is incorporated herein by reference.

The antenna assembly in accordance with the present invention incorporates a connector 24 directly secured to the antenna unit 10. The connector is an SMA-pattern male connector. In this embodiment of the invention, the connector has an inner connection member in the form of a conductive axial pin 26, an outer connection member in the form of a generally cylindrical connector shell 28 and a cylindrical dielectric spacer 30. Completing the components at the assembly stage is a solder ring 32 having an inner diameter approximately matching the outer diameter of the shield conductor 16 of the feed structure and an outer diameter approximately matching the inner diameter of the connector shell 28.

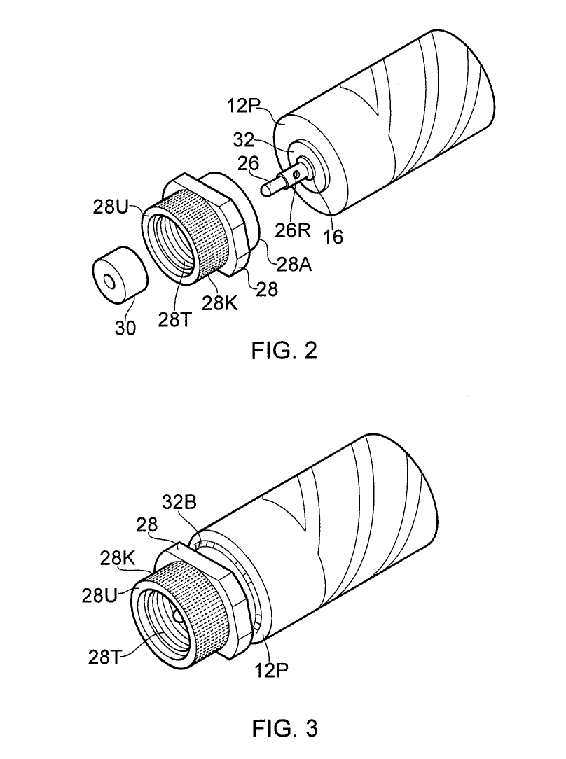

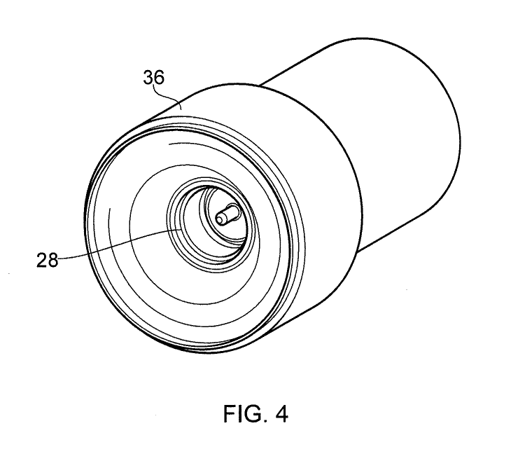

Assembly of the parts described above with reference to FIG. 1 will now be described with reference to FIGS. 2 and 3. In the end-product of the assembly process, the connector pin 26 is secured to the inner rod 18 of the transmission line section and the outer connector shell 28 is directly secured to the proximal surface 12P of the core 12, the dielectric spacer 13 being an interference-fit in the shell 28 and located by an internal shoulder (not shown) in the shell so as to support the inner pin 26 laterally with respect to the shell 28 and to insulate one from the other.

Referring to FIG. 2, the first part of the assembly process comprises the assembly of the feed structure 14, and its insertion in the axial bore of the antenna unit core 12, so that the shield conductor 16 projects by a short distance beyond the plated proximal surface 12P of the core. This is followed by the placing of the solder ring 32 around the projecting proximal end of the shield conductor 16. Solder ring 32 now abuts the plated proximal surface 12P of the core and, when heated, connects the plated surface to the shield conductor. The inner connector pin 26 has a small-diameter inner bore dimensioned to receive the inner conductor rod 18 of the feed structure. A laterally directed relief aperture 26R in the bored section of the connector pin 26 facilitates the soldering of the pin 26 to the rod 18.

In another assembly step the dielectric spacer 30 which has an internal diameter matching the external diameter of the pin 26 and an external diameter sized to be an interference-fit in the shell 28, is inserted into the shell 28 until it meets the internal shoulder.

Next, the outer connector shell 28, which has a first circular edge portion 28A directed distally of the antenna assembly and a second circular unattached edge portion 28U directed proximally, is placed, together with the spacer 30, over the pin 26 so that it abuts the plated proximal surface 12P of the core 12. As shown in FIG. 3, when the assembly is heated, solder along the junction between the first edge portion 28A of the connector shell 28 and the plated proximal surface 12P of the core 12 forms a solder bond 33 between the connector edge portion and the plated surface.

Once the connector shell 28 is secured, the antenna unit and the connector together form a rigid assembly which can be screwed onto a female SMA connector forming part of equipment to which the antenna is to be mounted. It will be noted that the connector shell 28 has an inner thread 28T for this purpose. It will also be noted that a portion 28K of the outer surface of the connector shell 28 is knurled so that, when the antenna unit and connector assembly is encapsulated in a polymeric cover 36, as shown in FIG. 5, the moulding of the cover 36 to the knurled portion 28K of the connector shell 28 rotationally fixes one with respect to the other. Accordingly, the entire assembly, including the cover 36, can be screwed to the receiving connector on the equipment to which the assembly is to be mounted by gripping the outside of the cover 36 and rotating it.

In another variant of the invention, not shown, the inner connector member of the coaxial connector and the transmission line section inner conductor 18 are a one-piece component, thereby avoiding the need for the soldering of a separate pin to the inner conductor rod 18.

A particular advantage of the antenna assembly described above and shown in the drawings is that the distributed bonding of the conductor connector body or shell 28 to a conductive outer surface 12P on the antenna unit produces a strong and rigid assembly. The comparatively short distance between the unattached edge 28U of the connector body or shell 28 and the antenna unit results in a short lever arm between the outer portions of the connector shell and the joint between the shell and the antenna unit, further contributing to the assembly strength.

What is claimed is:

1. An antenna assembly comprising the combination of a dielectrically loaded antenna unit for operation at a frequency in excess of 200 MHz and a connector secured to the antenna unit, wherein the antenna unit has a side surface and end surfaces and comprise a solid insulative dielectric core and an antenna element structure having a plurality of conductive antenna elements arranged on or adjacent the outer surface of the core, and wherein the connector comprises an inner connection member which is coupled to at least one of the antenna elements and which projects from a central portion of one of the end surfaces of the antenna unit, and a hollow outer connection member which encircles the inner connection member and has an unattached annular edge and an attached annular edge, the attached annular edge being bonded to the said one end surface of the antenna unit.

2. An antenna assembly according to claim 1, wherein the outer connection member is a conductive sleeve having a generally circular attached edge and wherein the said one surface of the antenna unit has a conductive outer layer, the attached edge of the sleeve being conductively bonded along its circumference directly to the said conductive outer layer.

3. An antenna according to claim 1, wherein the antenna unit has a central axis and the outer connection member has a circular cross-section centred on the axis

4. An antenna assembly according to claim 1, wherein the connector further comprises a sold insulative spacer inside the outer connection member and surrounding the inner connection member.

5. An antenna assembly according to claim 1, wherein the antenna unit comprises a helical antenna having a cylindrical core and a plurality of conductive helical antenna elements on the outer cylindrical surface of the core, and wherein the outer connection member is coupled to at least one of the helical antenna elements.

6. An antenna assembly according to claim 1, wherein the antenna unit and the connector have a common central axis and wherein the inner connection member is a connector pin lying on the axis.

7. An antenna assembly according to claim 6, wherein the antenna unit is a backfire helical antenna having an axial feeder structure passing through the core, and wherein inner connection member forms an extension of one of the conductors of the feeder structure.

8. An antenna assembly according to claim 7, wherein the antenna unit core is cylindrical and the antenna element structure comprises a plurality of conductive helical antenna elements on the cylindrical outer surface of the core and extending from a region of a feeder connection on a distal transverse surface of the core in the direction of a proximal transverse surface of the core, and wherein a proximal region of the core has a conductive coating, and the outer connection member of the connector is soldered to the conductive coating.

9. An antenna assembly according to claim 8, wherein the outer connection member is a generally cylindrical conductive shell with a circular attached edge soldered to the conductive coating along the whole length of the attached edge.

10. An antenna according to claim 1, further comprising a polymeric covering moulded over the combination of the antenna unit and the connector, wherein the outer connector member has a non-circular outer profile to resist rotation of the connector inside the moulded covering.

11. A method of making an antenna assembly as claimed in claim 1, the said one end surface of the antenna unit having a conductive coating, wherein the method comprises locating a solder ring and the attached annular connector edge on the said one end surface, the solder ring being in contact with the annular edge, and heating the antenna unit and the connector to cause the solder of the solder ring to flow between the conductive coating and the connector edge to form a solder bond between them.

12. A method according to claim 11, the connector including an annular dielectric spacer between the inner and outer connector members, wherein the method includes placing the spacer around the inner connection member at the same time as or before locating the outer connection member on the said one end surface of the antenna unit so that the spacer is trapped against the antenna unit when the bonding of the outer connector member to the antenna unit has been performed.

13. A method according to claim 11, wherein the inner connection member is an elongate conductive member and the method comprises conductively securing the inner connection member to a conductor of an axial feed conductor forming part of the antenna unit before securing the outer connection member to the antenna unit.
